(19) United States
(12) Patent Application Publication
(10) Pub. No.: US 2022/0416371 A1
(43) Pub. Date: Dec. 29, 2022

(54) CELL-CONTACTING SYSTEM FOR A BATTERY MODULE AND BATTERY MODULE WITH SUCH A CELL-CONTACTING SYSTEM

(71) Applicant: Diehl AKO Stiftung & Co. KG, Wangen (DE)

(72) Inventors: Christoph Heinle, Weitnau (DE); Mateusz Kurpiel, Wangen (DE)

(21) Appl. No.: 17/847,368

(22) Filed: Jun. 23, 2022

(30) Foreign Application Priority Data
Jun. 25, 2021 (DE) 10 2021 116 447.8

(51) Int. Cl. H01M 50/519; H01M 50/204; H01M 10/42; H01M 10/48; H01M 50/514

(52) U.S. Cl. CPC H01M 50/519; H01M 50/204; H01M 10/4257; H01M 10/482; H01M 10/486; H01M 50/514

(57) ABSTRACT

A cell-contacting system for a battery module having a plurality of battery cells includes a plurality of cell connectors for electrically conductively connecting cell terminals of different battery cells, and a printed circuit board having a plurality of signal lines each configured for connecting a signal source of one of the plurality of cell connectors to a signal management circuit or a connection interface. The signal sources of the cell connectors are electrically conductively connected to the signal lines of the printed circuit board through connection elements. At least one of the connection elements is configured in the form of a press-fit connection element. A battery module having the cell-contacting system is also provided.

### CROSS-REFERENCE TO RELATED APPLICATION

This application claims the priority, under 35 U.S.C. § 119, of German Patent Application DE 10 2021 116 447.8, filed Jun. 25, 2021; the prior application is herewith incorporated by reference in its entirety.

### FIELD AND BACKGROUND OF THE INVENTION

The present invention relates to a cell-contacting system for a battery module having a plurality of battery cells, and to a battery module having such a cell-contacting system.

Cell management controllers (CMC), which monitor the individual battery cells of the battery module in order to carry out, for example, charging processes and balancing of voltages and states of charge, temperature-control processes, etc. for the battery cells, require a cell-contacting system for contacting the battery cells in order to obtain corresponding measurement signals, for example of the potentials and temperatures of the battery cells. Conventional cell-contacting systems usually require a high manufacturing and assembly effort for the connection of the signal sources to the signal line system.

### SUMMARY OF THE INVENTION

It is accordingly an object of the invention to provide an improved cell-contacting system for a battery module and a battery module with such a cell-contacting system, which overcome the hereinafore-mentioned disadvantages of the heretofore-known systems and modules of this general type and which have a simple structure and a simple and reliable assembly.

With the foregoing and other objects in view there is provided, in accordance with the invention, a cell-contacting system for a battery module having a plurality of battery cells, a plurality of cell connectors for electrically conductively connecting cell terminals of different battery cells, and a (preferably rigid) printed circuit board having a plurality of signal lines each for connecting a signal source of one of the plurality of cell connectors to a signal management circuit or a connection interface. The plurality of cell connectors serve as a power supply line system and the printed circuit board serves as a signal line system. The signal sources of the plurality of cell connectors are each electrically conductively connected to one of the plurality of signal lines of the printed circuit board through at least one connection element. According to the invention, at least one, preferably a plurality, more preferably all, of these connection elements is in the form of a press-fit connection element having a first press-in portion for pressing into a hole in the printed circuit board, a second press-in portion for pressing into a hole in the signal source, and a connection portion between the first and second press-in portions.

The dependent claims relate to particularly advantageous configurations and developments of the invention.

The use of such press-fit connection elements for electrically conductive connection of the signal sources of the cell connectors to the signal lines of the printed circuit board has several advantages. The press-fit technology allows simple, fast and automated assembly of the connection elements and thus simple, fast and automated connection of the signal sources to the signal line system. This advantage arises in particular from the fact that soldering or welding processes are avoided. Furthermore, in addition to the electrical connection function, these press-fit technology connection elements also have a mechanical connection function and a thermal connection function without additional measures. The press-fit connection elements can be used particularly well in conjunction with a rigid printed circuit board, which results in further advantages because a rigid printed circuit board allows easy handling during manufacturing and assembly and also allows the mounting of components, such as electronic circuit elements, thereon. Overall, the cell-contacting system can thus be produced simply, reliably, and with positional accuracy, which also makes it possible to produce the entire battery module more easily and more reliably.

The cell-contacting system preferably further includes at least one signal management circuit connected to the signal lines of the printed circuit board. The at least one signal management circuit can, for example, be integrated into the rigid printed circuit board or connected to the printed circuit board as an external circuit through a corresponding connection interface. The integrated or external signal management circuit is additionally preferably connected to a battery module controller through a connection interface. The cell-contacting system, the signal management circuit and the battery module controller can also be referred to together as a cell management controller (CMC).

Preferably, the signal sources have at least one voltage tap point provided on one of the plurality of cell connectors and/or at least one temperature-measuring device provided on one of the plurality of cell connectors. Preferably, all cell connectors are each provided with a voltage tap point connected to a signal line of the printed circuit board. Preferably, some or even all of the cell connectors each have a temperature-measuring device attached thereto that is connected to a signal line of the printed circuit board.

The at least one temperature-measuring device preferably has a sensor printed circuit board with a temperature-sensing element, the sensor printed circuit board being connected to the corresponding cell connector through a contact element and being connected to a signal line of the printed circuit board through a connection element. In this embodiment, the connection element for the temperature-measuring device is preferably in the form of a press-fit connection element having a first press-in portion for pressing into a hole in the printed circuit board, a second press-in portion for pressing into a hole in the sensor printed circuit board, and a connection portion between the first and second press-in portions. In addition, in this embodiment, due to the multiple functionality of the press-fit technology mentioned above, the contact element for the temperature-measuring device can also be in the form of a press-fit contact element having a first press-in portion for pressing into a hole in the cell connector, a second press-in portion for pressing into a hole in the sensor printed circuit board, and a connection portion between the first and second press-in portions. Preferably, the first and second press-in portions of the press-fit contact element can be disposed one behind the other with substantially coinciding longitudinal axes, and the connection portion of the press-fit contact member may run substantially along the common longitudinal axis between the press-in portions.

The at least one voltage tap point can be formed by a corresponding cell connector. In this embodiment, the connection element for the voltage tap point is preferably in the form of a press-fit connection element, which has a first press-in portion for pressing into a hole in the printed circuit board, a second press-in portion for pressing into a hole in the cell connector, and a connection portion between the first and second press-in portions.

In one embodiment of the invention, the cell-contacting system has at least one press-fit connection element, in which the first press-in portion and the second press-in portion are disposed one behind the other with substantially coinciding longitudinal axes, and the connection portion runs substantially along the common longitudinal axis between the press-in portions. This embodiment of the press-fit connection element is particularly suitable for connecting a temperature-measuring device to a signal line of the printed circuit board, if the temperature-measuring device is disposed on a cell connector in such a way that the device (for example its sensor printed circuit board) also protrudes somewhat above the printed circuit board.

In one embodiment of the invention, the cell-contacting system has at least one press-fit connection element in which the first press-in portion and the second press-in portion are disposed side by side with substantially parallel longitudinal axes, and the connection portion of the press-fit connection element runs transversely (for example, substantially perpendicularly) to the longitudinal axes of the press-in portions between the press-in portions. This embodiment of the press-fit connection element is particularly suitable for connecting a voltage tap point to a signal line of the printed circuit board or also for connecting a temperature-measuring device, if the latter is disposed completely only on a cell connector so that the device does not also extend over the printed circuit board, to a signal line of the printed circuit board.

The cell-contacting system of the invention can also include at least one press-fit connection element of the first-mentioned embodiment (press-in portions one behind the other) and at least one press-fit connection element of the second-mentioned embodiment (press-in portions side by side).

In a press-fit connection element of the second-mentioned embodiment (having press-in portions disposed side by side), the connection portion of the press-fit connection element can be (i) configured in such a way that the first and second press-in portions of the press-fit connection element are positioned at the same height, or (ii) configured in such a way that the first and second press-in portions of the press-fit connection element are positioned at different heights. The first variant is suitable for connecting a voltage tap point or temperature-measuring device to a signal line of the printed circuit board when the upper side of the printed circuit board and the upper side of the cell connector or temperature-measuring device are positioned at substantially the same level in the battery module or are oriented in substantially the same plane. The second variant is suitable for connecting a voltage tap point or temperature-measuring device to a signal line of the printed circuit board when the upper side of the printed circuit board and the upper side of the cell connector or temperature-measuring device are positioned at different levels in the battery module or extend in different planes.

In one embodiment of the invention, the cell-contacting system has at least one press-fit connection element in which the connection portion is at least partially elastic in such a way that it allows movement of the corresponding cell connector relative to the printed circuit board in a plane parallel to the printed circuit board plane. The flexibility thus formed allows the connection element to compensate for movements and swellings of the battery cells that may occur, for example, during charging and discharging cycles.

In one embodiment of the invention, the cell-contacting system has at least one press-fit connection element in which the connection portion is configured to be rigid in such a way that it prevents movement of the corresponding cell connector relative to the printed circuit board.

The cell-contacting system of the invention can also include at least one press-fit connection element of the first-mentioned embodiment (having an elastic connection portion) and at least one press-fit connection element of the second-mentioned embodiment (having a rigid connection portion). The embodiment of the press-fit connection elements can be selected, for example, depending on the application (for example on the type of battery cells).

In a further embodiment of the invention, the printed circuit board of the cell-contacting system has at least one ventilation opening, for example in the form of a plurality of holes or a gap. The ventilation openings can support a cooling process of the battery cells under the rigid printed circuit board region.

With the objects of the invention in view, there is also provided a battery module that has a plurality of battery cells and a cell-contacting system of the invention as described above. With this battery module, the same advantages can be achieved as explained above in conjunction with the cell-contacting system according to the invention.

The battery cells are connected to each other through the cell connectors of the cell-contacting system and can be connected to a consumer or a charging system through an electrical connection of the battery module. The battery cells and the cell-contacting system are preferably both accommodated in a module housing. The invention is not limited to any particular type, number, size or arrangement of the plurality of battery cells. In particular, the invention is also usable for Li-ion battery modules.

The battery module generally further has at least one battery module controller for operating the battery module, the battery module controller being connected to the at least one signal management circuit (integrated in the printed circuit board or connected to the printed circuit board as an external circuit through a connection interface). The module controller performs, for example, charging processes, balancing of the voltages and the states of charge, temperature-control processes such as, in particular, cooling processes, and the like, at least partially depending on the measurement signals obtained by the cell-contacting system.

The invention is advantageously applicable to battery modules for vehicles, in particular electric vehicles and hybrid vehicles and in particular motor vehicles and motorcycles, and also to energy storage systems and other electrical appliances (for example, electronic household appliances).

Other features which are considered as characteristic for the invention are set forth in the appended claims.

Although the invention is illustrated and described herein as embodied in a cell-contacting system for a battery module and a battery module with such a cell-contacting system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective plan view of a battery module according to an exemplary embodiment of the invention;

FIG. 2 is a plan view of a cell-contacting system according to an exemplary embodiment of the invention for the battery module of FIG. 1;

FIG. 3 is an enlarged partial view of the cell-contacting system of FIG. 2;

FIG. 4A is a partial perspective view of a connector of a voltage tap point according to an exemplary embodiment of the invention;

FIG. 4B is a partial perspective view of the exemplary embodiment of FIG. 4A before pressing in the press-fit connection elements;

FIG. 5A is a partial perspective view of a connector of a temperature-sensing element according to an exemplary embodiment of the invention;

FIG. 5B is a partial perspective view of the exemplary embodiment of FIG. 5A before pressing in the press-fit connection elements;

FIG. 6A is a partial perspective view of a connector of a temperature-sensing element according to a further exemplary embodiment of the invention;

FIG. 6B is a partial perspective view of the exemplary embodiment of FIG. 6A before pressing in the press-fit connection elements; and

FIGS. 7A-7D are perspective views of press-fit connection elements and/or press-fit contact elements according to various exemplary embodiments of the invention for the connections of the voltage tap points or temperature-sensing elements.

### DETAILED DESCRIPTION OF THE INVENTION

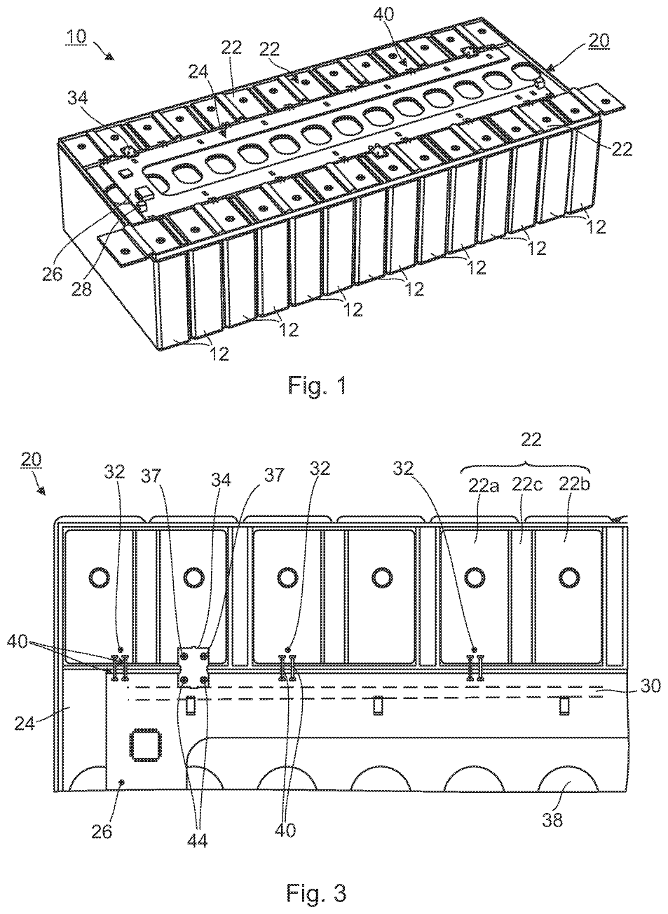

Referring now to the figures of the drawings in detail and first, particularly, to FIGS. 1-3 thereof, there is seen an exemplary embodiment of a battery module with a cell-contacting system according to the invention.

The battery module 10 has a plurality of battery cells (for example Li-ion battery cells) 12. In this exemplary embodiment, the battery cells 12 are disposed side by side in the right-left direction of FIG. 1 and each have a negative terminal in the upper or lower end region shown in FIG. 1 and a positive terminal in the lower or upper end region shown in FIG. 1, the negative and positive terminals of the battery cells 12 being disposed alternately so that a negative terminal of one battery cell is next to a positive terminal of an adjacent battery cell.

The battery module 10 further has a cell-contacting system 20 disposed above the battery cells 12. The battery cells 12 together with the cell-contacting system 20 are usually disposed in a module housing (not shown).

The cell-contacting system 20 has a plurality of cell connectors 22 forming a power supply line system. In this exemplary embodiment, the cell connectors 22 each have two contact regions 22a, 22b and a (preferably elastic) compensation region 22c between the two contact regions 22a, 22b and are mounted on the battery cells 12 in such a way that they each couple the negative terminal of a battery cell 12 to the positive terminal of an adjacent battery cell 12 through their two contact regions 22a, 22b, resulting in a series connection of the battery cells 12 in the battery module 10. The battery cells 12 are additionally connectable to a consumer or a charging system through an electrical connection of the battery module 10.

The cell-contacting system 20 further includes a preferably rigid printed circuit board 24 forming the signal conduction system and being disposed over the battery cells 12 in the region between the two rows of cell connectors 22 along the entire length of the battery cell array. The shape and size of the printed circuit board 24 can, in principle, be adapted to any construction of battery modules, in particular to any arrangements, sizes or numbers of battery cells.

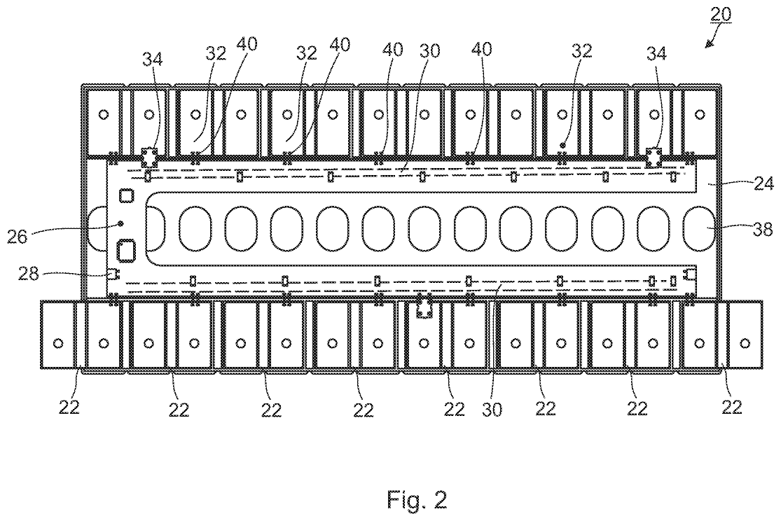

As shown in FIGS. 1 and 2, the printed circuit board 24 has a plurality of ventilation holes acting as ventilation openings 38 for supporting a cooling process of the battery cells 12 located thereunder.

As indicated only schematically in FIGS. 2 and 3, the printed circuit board 24 has a plurality of signal lines 30 each connecting a signal source 32, 34 of a cell connector 22 to an electronic signal management circuit 26. The signal management circuit 26 is configured, for example, to perform the voltage measurement process and to evaluate the measurement signals obtained from the signal sources of the cell connectors 22. In this exemplary embodiment, the signal management circuit 26 is integrated on the printed circuit board 24 and connected to a connection interface 28, through which the signal management circuit 26 can be connected to a battery module controller. This battery module controller serves, for example, to perform charging processes, balancing of the voltages and the states of charge, temperature-control processes such as, in particular, cooling processes, etc., these processes being performed at least partially depending on the measurement signals obtained by the cell-contacting system 20 or the measurement values obtained by the signal management circuit 26 thereof. In an alternative embodiment of the invention, the signal management circuit 26 can also be configured externally to the printed circuit board 24. In this case, the signal lines 30 of the printed circuit board 24 are directly connected to the connection interface 28 and the external signal management circuit is coupled to the connection interface 28 of the printed circuit board 24 and is additionally coupled to the battery module controller through a further connection interface.

As indicated in FIGS. 1 to 3, there are two types of signal sources in this cell-contacting system 20. Firstly, all (optionally only a majority) of the cell connectors 22 have a voltage tap point 32 as a first signal source type for measuring the voltage of the battery cells 12. In addition, a few (optionally also all) of the cell connectors 22 have a temperature-measuring device 34 as a second signal source type for measuring the temperature of the battery cells 12.

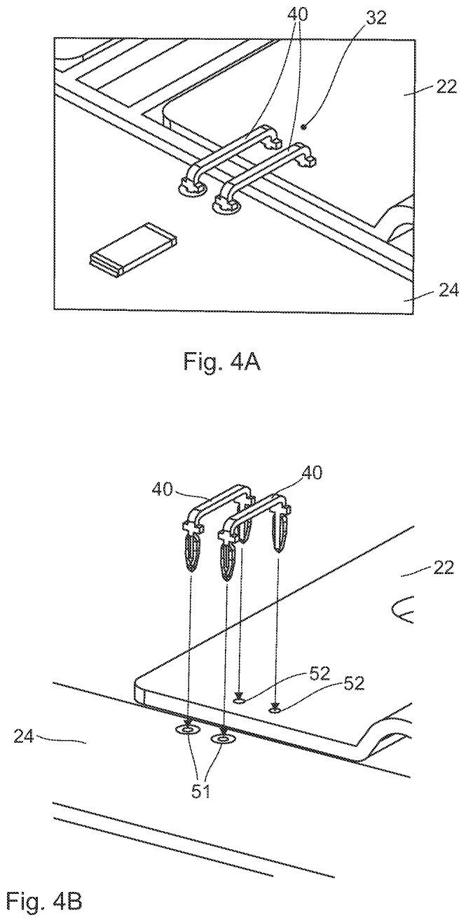

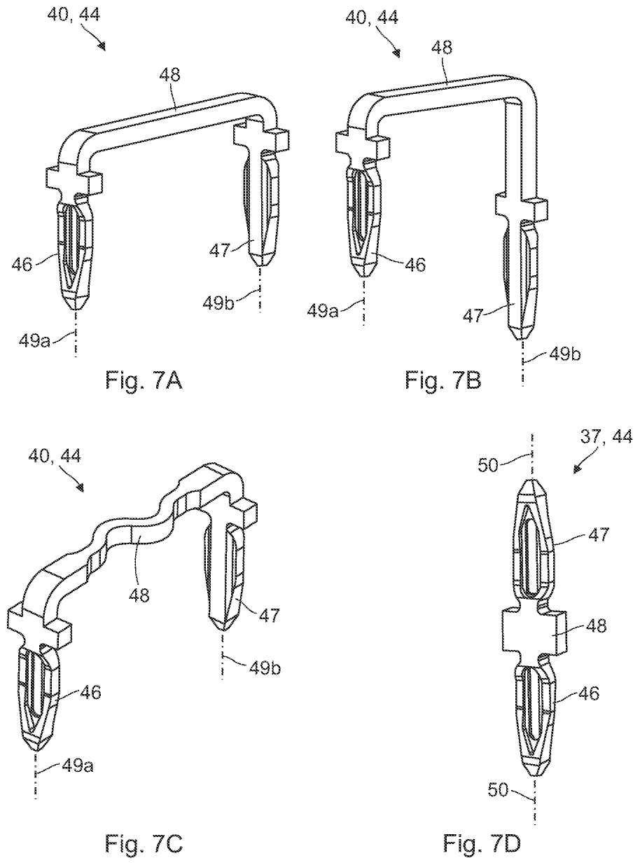

The voltage tap points 32 can each be formed directly by a contact region 22a, 22b of a cell connector 22. At least one (in this exemplary embodiment, two) connection element 40 in the form of a press-fit connection element is provided in each case for connecting the voltage tap points 32 to the signal lines 30 of the printed circuit board 24. The structures and modes of operation of these press-fit connection elements 40 are illustrated in FIGS. 4A-4B and 7A-C.

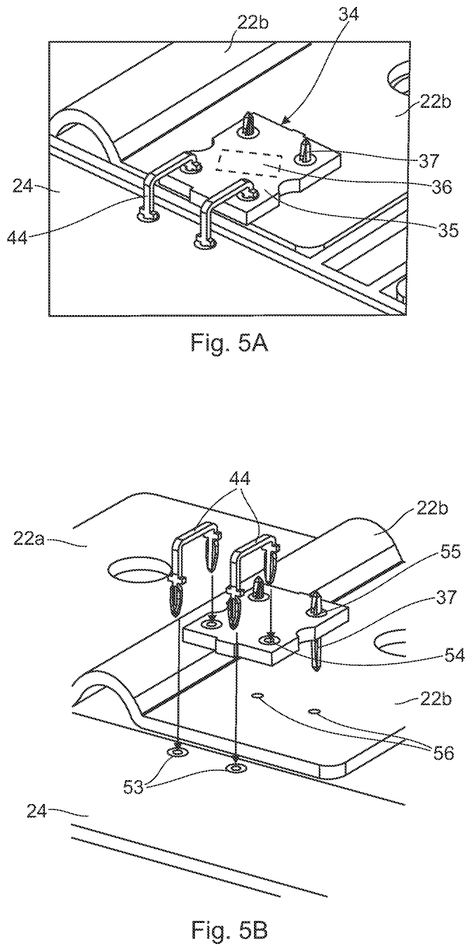

The temperature-measuring devices 34 are each mounted on a cell connector 22. In order to connect the temperature-measuring devices 34 to the signal lines 30 of the printed circuit board 24, at least one (in this exemplary embodiment, two) connection element 44 is provided in each case and is also in the form of a press-fit connection element. The structures and modes of operation of these press-fit connection elements 44 are illustrated in FIGS. 5A-B, 6A-B and 7A-D.

Referring now to FIGS. 4A-4B and 7A-7C, the press-fit connection elements 40 for connecting the voltage tap points 32 to the signal lines 30 of the printed circuit board 24 will be explained in greater detail in an exemplary manner. These press-fit connection elements 40 each have a first press-in portion 46 pressed into a defined hole 51 in the printed circuit board 24, a second press-in portion 47 pressed into a defined hole 52 in a contact region 22a, 22b of a cell connector 22, and a connection portion 48 between these two press-in portions 46, 47. The press-fit connection elements 40 are formed of metal and form an electrical and mechanical connection between the voltage tap point 32 or the cell connector 22 and the signal line 30 or the printed circuit board 24. The connection is made simply by pressing the press-in portions 46, 47 into the holes 51, 52, for example automatically, without the need for a soldering or welding process. The press-in portions 46, 47 are at least partially dimensionally elastic and in their initial state have a somewhat larger diameter than the holes 51, 52, so that, when pressed in, the press-in portions and/or the holes are somewhat deformed and form a secure mechanical and electrical contact. The two press-in portions 46, 47 are disposed side by side with substantially parallel longitudinal axes 49a, 49b and the connection portion 48 runs substantially perpendicular to the longitudinal axes 49a, 49b of the two press-in portions 46, 47. When the upper side of the printed circuit board 24 and the upper side of the cell connector 22 (or its contact region 22a, 22b) are positioned at substantially the same level in the battery module or are oriented in substantially the same plane (as can be roughly seen in FIGS. 4A-4B), then the connection portion 47 is additionally configured in such a way that the two press-in portions 46, 47 are positioned at (approximately) the same level, as shown in FIG. 7A. On the other hand, if the upper side of the printed circuit board 24 and the upper side of the cell connector 22 (or its contact region 22a, 22b) are positioned at different levels in the battery module 10 or are oriented in different planes, then the connection portion 47 can be configured in such a way that the two press-in portions 46, 47 are positioned at different heights, as illustrated by way of example in FIG. 7B. Depending on the relative positioning of the printed circuit board and the cell connectors 22, in this embodiment the second press-in portion 47 can optionally be positioned lower than the first press-in portion 46 (see FIG. 7B) or the first press-in portion 46 can be positioned lower than the second press-in portion 47 (not shown). It is additionally possible to make the connection portion 48 of the press-fit connection element 40 at least partially elastic, as indicated in FIG. 7C, so that the connection element 40 can allow movement of the corresponding cell connector 22 relative to the printed circuit board 24 in a plane parallel to the plane of the printed circuit board. This flexibility allows the connection element to compensate for movement and swelling of the battery cells 12 that may occur, for example, during charging and discharging cycles. This variant with an elastic connection portion 48 can be used both for connection elements 40 with press-in portions 46, 47 positioned at the same height (see FIG. 7C) and for connection elements 40 with press-in portions 46, 47 positioned at different heights (combination of FIGS. 7B and 7C, not shown). Alternatively, the connection portion 48 can also be configured to be rigid in such a way that it prevents movement of the corresponding cell connector 22 relative to the printed circuit board 24, if desired for any reason.

Since the press-fit technology is basically known to the person skilled in the art, there is no need to explain further details and modes of operation. In addition, various embodiments of the press-fit technology can, in principle, be used for the cell-contacting system according to the invention.

Referring now to FIGS. 5A-5B and 7A-7D, a first variant of the temperature-measuring device 34 and its press-fit connection elements 44 for connection to the signal lines 30 of the printed circuit board 24 will be explained in more detail. The temperature-measuring device 34 has a small sensor printed circuit board 35 with an integrated temperature-sensing element 36. The temperature-sensing element 36 is, for example, an NTC resistor or an NTC thermistor. The sensor printed circuit board 35 is connected to the corresponding cell connector 22 through at least one (in this exemplary embodiment, two) contact element 37 in order to transmit and sense thermal energy from the cell connector 22 to the temperature-sensing element 36. The contact element 37 is likewise configured using press-fit technology. This press-fit contact element 37 has a first press-in portion 46 that is pressed into a defined hole 56 in the cell connector 22, a second press-in portion 47 that is pressed into a defined hole 55 in the sensor printed circuit board 35, and a connection portion 48 between these two press-in portions 46, 47. The press-fit contact element 37 forms a thermal and mechanical connection between the temperature-measuring device 34 and the cell connector 22. The connection is made simply by pressing the press-in portions 46, 47 into the holes 51, 52, for example automatically, without the need for a soldering or welding process. In this exemplary embodiment, the sensor printed circuit board 35 is positioned relative to the cell connector 22 in such a way that the two holes 55, 56 are opposite each other. For this reason, the two press-in portions 46, 47 are disposed one behind the other with a substantially common longitudinal axis 50, and the connection portion 48 runs substantially along the common longitudinal axis 50 between the two press-in portions 46, 47, as shown in FIG. 7D. If, on the other hand, the sensor printed circuit board 35 is positioned differently relative to the cell connector 22, the press-fit contact element 37 can also be configured analogously to the press-fit connection element shown in FIG. 7B with press-in portions 46, 47 disposed side by side.

In this first variant of the temperature-measuring device 34, the press-fit connection element 44 for connecting the temperature-measuring device 34 to a signal line 30 of the printed circuit board 24 is configured analogously to FIG. 7B, since the cell connectors 22 are positioned at the same level as the printed circuit board 24, but the sensor printed circuit board 35 is positioned higher than the printed circuit board 24 by being attached to the cell connector 22. In other words, this press-fit connection element 44 has a first, lower press-in portion 46, which is pressed into a defined hole 53 in the printed circuit board 24, a second, higher press-in portion 47, which is pressed into a defined hole 54 in the sensor printed circuit board 35, and a connection portion 48 between these two press-in portions 46, 47. In all other respects, the press-fit connection element 44 for the temperature-measuring device 34 corresponds to the press-fit connection element 40 for the voltage tap point 32 and can also adopt any other variants (for example, FIG. 7A and/or FIG. 7C) as required.

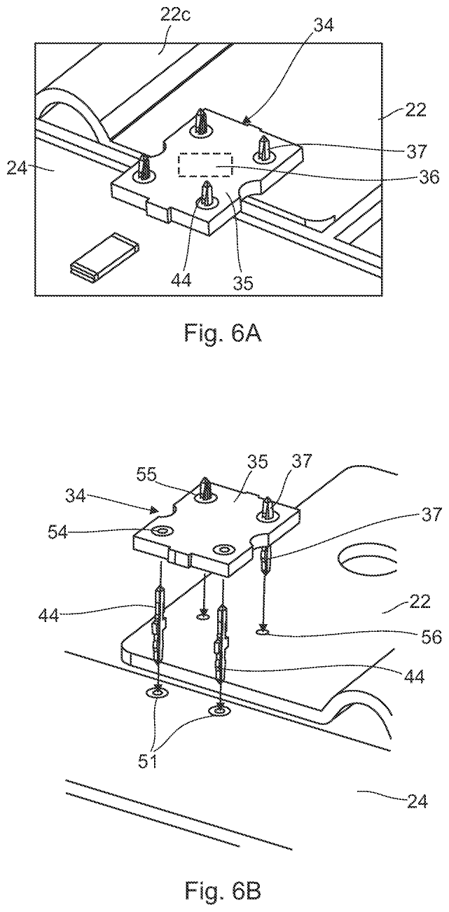

Referring now to FIGS. 6A-B and 7D, a second variant of the temperature-measuring device 34 and its press-fit connection elements 44 for connecting to the signal lines 30 of the printed circuit board 24 are explained in more detail in an exemplary manner. The temperature-measuring device 34 is basically configured as in the first variant of FIGS. 5A-5B, but is positioned on the cell connector 22 in such a way that it also extends somewhat above the printed circuit board 24. As in the first variant, the press-fit contact elements 37 correspond to the configuration shown in FIG. 7D. The press-fit connection elements 44 for connection to a signal line 30 of the printed circuit board 24 are also of the same construction as shown in FIG. 7D, unlike in the first variant. That is to say, these press-fit connection elements 44 have a first press-in portion 46 that is pressed into a defined hole 51 in the printed circuit board 24, a second press-in portion 47 that is pressed into a defined hole 54 in the sensor printed circuit board 35, and a connection portion 48 between these two press-in portions 46, 47, the two press-in portions 46, 47 being disposed one behind the other with a substantially common longitudinal axis 50 and the connection portion 48 running substantially along the common longitudinal axis 50 between the two press-in portions 46, 47.

With reference to FIGS. 4A to 7D, several specific exemplary embodiments of the press-fit connection elements 40, 44 and the temperature measuring device 34 have been explained. Within the scope of the invention defined in the appended claims, further embodiments are also possible in which individual features of these figures are omitted, features are added to these figures, or features from different figures are combined.

The described battery modules 10 with the cell-contacting systems 20 according to the invention can be used, for example, for vehicles, in particular electric vehicles and hybrid vehicles and in particular motor vehicles and motorcycles, or for energy storage systems or for other electrical appliances (for example electronic household appliances).

The following is a summary list of reference numerals and the corresponding structure used in the above description of the invention.

### LIST OF REFERENCE NUMERALS

10 battery module
12 battery cells
20 cell-contacting system
22 cell connectors (power supply line system)
22a, b contact regions of the cell connectors
22c compensation regions of the cell connectors
24 printed circuit board (signal line system)
26 signal management circuit
28 connection interface
30 signal lines
32 voltage tap point (signal source)
34 temperature-measuring device (signal source)
35 sensor printed circuit board
36 temperature-sensing element
37 press-fit contact element
38 ventilation openings
40 press-fit connection element to 32
44 press-fit connection element to 34
46 first press-in portion
47 second press-in portion
48 connection portion between 46 and 47
51 hole in the printed circuit board for 40
52 hole in the cell connector for 40
53 hole in the printed circuit board for 44
54 hole in the sensor printed circuit board for 44
55 hole in the sensor printed circuit board for 37
56 hole in the cell connector for 37

1. A cell-contacting system for a battery module having a plurality of battery cells, the cell-contacting system comprising:
a plurality of cell connectors for electrically conductively connecting cell terminals of different battery cells, said plurality of cell connectors having signal sources;
a printed circuit board having a plurality of signal lines each configured to connect said signal source of a respective one of said plurality of cell connectors to a signal management circuit or a connection interface; and
connection elements, at least one of said connection elements electrically conductively connecting each of said signal sources of said plurality of cell connectors to a respective one of said plurality of signal lines of said printed circuit board;
at least one of said connection elements configured as a press-fit connection element having a first press-in portion to be pressed into a hole in said printed circuit board, a second press-in portion to be pressed into a hole in one of said signal sources, and a connection portion connected between said first and second press-in portions.

2. The cell-contacting system according to claim 1, wherein said signal sources have at least one of:
at least one voltage tap point provided on one of said plurality of cell connectors, or
at least one temperature-measuring device mounted on one of said plurality of cell connectors.

3. The cell-contacting system according to claim 2, wherein:
said temperature-measuring device has a sensor printed circuit board with a temperature-sensing element;
a contact element connects said sensor printed circuit board to a corresponding one of said plurality of cell connectors; and
said sensor printed circuit board is connected to one of said plurality of signal lines of said printed circuit board by one of said connection elements.

4. The cell-contacting system according to claim 3, wherein one of said connection elements for said temperature-measuring device is configured as a press-fit connection element having a first press-in portion for pressing into a hole in said printed circuit board, a second press-in portion for pressing into a hole in said sensor printed circuit board, and a connection portion connected between said first and second press-in portions.

5. The cell-contacting system according to claim 3, wherein said contact element for said temperature-measuring device is configured as a press-fit contact element having a first press-in portion for pressing into a hole in one of said plurality of cell connectors, a second press-in portion for pressing into a hole in said sensor printed circuit board, and a connection portion connected between the first and second press-in portions.

6. The cell-contacting system according to claim 5, wherein said first and second press-in portions of said press-fit contact element for said temperature-measuring device are disposed one behind another with a common longitudinal axis, and said connection portion of said press-fit contact element extends along said common longitudinal axis between said press-in portions.

7. The cell-contacting system according to claim 2, wherein:
said voltage tap point is formed by a corresponding one of said plurality of cell connectors; and
said connection element for said voltage tap point is configured as a press-fit connection element having a first press-in portion for pressing into a hole in said printed circuit board, a second press-in portion for pressing into a hole in one of said plurality of cell connectors, and a connection portion connected between said first and second press-in portions.

8. The cell-contacting system according to claim 4, wherein said first and second press-in portions of at least one of said press-fit connection elements are disposed one behind another with a common longitudinal axis, and said connection portion runs along said common longitudinal axis between said press-in portions.

9. The cell-contacting system according to claim 4, wherein said first and second press-in portions of at least one of said press-fit connection elements are disposed side by side with parallel longitudinal axes, and said connection portion runs transversely to said longitudinal axes of said press-in portions between said press-in portions.

10. The cell-contacting system according to claim 5, wherein said first and second press-in portions of at least one of said press-fit connection elements are disposed side by side with parallel longitudinal axes, and said connection portion runs transversely to said longitudinal axes of said press-in portions between said press-in portions.

11. The cell-contacting system according to claim 10, wherein said connection portion of said press-fit connection element is configured to position said first and second press-in portions of said press-fit connection element at identical or different heights.

12. The cell-contacting system according to claim 4, wherein said connection portion of at least one of said press-fit connection elements is at least partially elastic and allows movement of a corresponding one of said plurality of cell connectors relative to said printed circuit board in a plane parallel to a plane of said printed circuit board.

13. The cell-contacting system according to claim 5, wherein said connection portion of at least one of said press-fit connection elements is at least partially elastic and allows movement of a corresponding one of said plurality of cell connectors relative to said printed circuit board in a plane parallel to a plane of said printed circuit board.

14. The cell-contacting system according to claim 4, wherein said connection portion of at least one of said press-fit connection elements is rigid and prevents movement of a corresponding one of said plurality of cell connectors relative to said printed circuit board.

15. The cell-contacting system according to claim 5, wherein said connection portion of at least one of said press-fit connection elements is rigid and prevents movement of a corresponding one of said plurality of cell connectors relative to said printed circuit board.

16. The cell-contacting system according to claim 1, wherein said printed circuit board has at least one ventilation opening formed therein.

17. A battery module comprising:
a plurality of battery cells; and
a cell-contacting system according to claim 1.
